(19) United States
(12) Patent Application Publication
(10) Pub. No.: US 2008/0144322 A1
(43) Pub. Date: Jun. 19, 2008

(54) LED Light Source Having Flexible Reflectors

(76) Inventors: Aizar Abdul Karim Norfidathul, Simpang Ampat (MY); Siew It Pang, Bayan Lepas (MY); Kheng Leng Tan, Bukit Jambul (MY); Tong Fatt Chew, Taman Sri Nibong (MY)

Correspondence Address: Kathy Manke;Avago Technologies Limited, 4380 Ziegler Road, Fort Collins, CO, 80525, US

(21) Appl. No.: 11/611,518

(22) Filed: Dec. 15, 2006

(51) Int. Cl. F21V 7/04

(52) U.S. Cl. 362/310

(57) ABSTRACT

A light source having a rigid substrate, a first LED, and a flexible reflector housing is disclosed. The rigid substrate has a first surface having a plurality of electrical traces formed thereon, the first LED die being disposed on the first surface and connected to two of the electrical traces. The rigid substrate also includes a plurality of external electrical connections for accessing the electrical traces. The reflector housing includes a layer of flexible material having at least one cavity extending through the layer of flexible material. The layer of flexible material is bonded to the first surface such that the cavity overlies the first LED die. The cavity has walls that reflect light generated in the first LED die. The first die can be encapsulated in a layer of silicone encapsulant. The reflector can likewise be constructed from silicone.

### BACKGROUND OF THE INVENTION

Light-emitting diodes (LEDs) are good candidates to replace incandescent and other light sources. LEDs have higher power to light conversion efficiencies than incandescent lamps and longer lifetimes. In addition, LEDs operate at relatively low voltages, and hence, are better adapted for use in many battery-powered devices. Furthermore, LEDs are a better approximation to point sources than a fluorescent source, and hence, are better adapted than fluorescent sources for lighting systems in which a point light source that is collimated or focused by an optical system is required.

An LED can be viewed as a three layer structure in which an active layer is sandwiched between p-type and n-type layers. Holes and electrons from the outer layers recombine in the active layer to produce light. Part of this light exits through the upper horizontal surface of the layered structure. Unfortunately, the materials from which the outer layers are constructed have relatively high indices of refraction compared to air or the plastic encapsulants used to protect the LEDs. As a result, a considerable portion of the light is trapped within the LED due to internal reflection between the outer boundaries of the LED. This light exits the LED through the side surfaces. To capture this light, the LEDs are often mounted in a reflecting cup whose sidewalls redirect the light from the sides of the LED into the forward direction. In addition, the cups are often filled with a clear encapsulant that protects the LED die and can provide additional optical functions such as having a surface that is molded to form a lens.

Prior art LED packages utilize rigid reflectors. Some designs utilize a white plastic such as PPA or LCP that is metal coated to provide a reflective surface. Other designs utilize metal-coated ceramic. Still other designs utilize metal housing. The rigid reflectors are rigidly attached to a substrate or formed by molding or casting with the substrate. From a cost perspective, plastic reflectors have significant advantages over metal or ceramic reflectors.

Unfortunately, the reflectors must be able to withstand relatively high processing temperatures. AuSn eutectic die attachment can subject the package to temperatures as high as 320 degrees centigrade. PPA and LCP plastics have problems when subjected to these temperatures including degradation of the plastic or loss of reflectivity. In addition, these materials absorb moisture. The absorbed moisture can cause failures during moisture sensitive processes such as SMT reflow.

As noted above, the cups are typically filled with an encapsulant. For many applications, the preferred encapsulant is silicone because of the resistance of this material to degradation by light in ultraviolet or blue regions of the spectrum. Unfortunately, the plastic and metallic cups do not bond well to the silicone encapsulant. This is particularly problematic during temperature cycling as the silicone has a different coefficient of thermal expansion, and hence, tends to delaminate from the cup after multiple temperature cycles during operation.

### SUMMARY OF THE INVENTION

The present invention includes a light source having a rigid substrate, a first LED, and a reflector housing. The rigid substrate has a first surface having a plurality of electrical traces formed thereon, the first LED die being disposed on the first surface and connected to two of the electrical traces. The rigid substrate also includes a plurality of external electrical connections for accessing said electrical traces. The reflector housing includes a layer of flexible material having at least one cavity extending through the layer of flexible material. The layer of flexible material is bonded to the first surface such that the cavity overlies the first LED die. The cavity has walls that reflect light generated in the first LED die. The first die can be encapsulated in a layer of silicone encapsulant. The reflector can likewise be constructed from silicone. The walls of the cavity can be coated with a reflective metallic coating.

### BRIEF DESCRIPTION OF THE DRAWINGS

FIG. 1 is a cross-sectional view of a multi-LED package.

FIG. 2 is a top view of the multi-LED package shown in FIG. 1.

FIG. 3 is a cross-sectional view of a portion of a light source according to one embodiment of the present invention.

FIG. 4 is a cross-sectional view of a portion of a light source according to another embodiment of the present invention.

FIG. 5 is a cross-sectional view of light source 80 through line 5-5 shown in FIG. 6.

FIG. 6 is a top view of light source 80.

FIG. 7 is a cross-sectional view of a light source according to another embodiment of the present invention.

### DETAILED DESCRIPTION OF EMBODIMENTS OF THE INVENTION

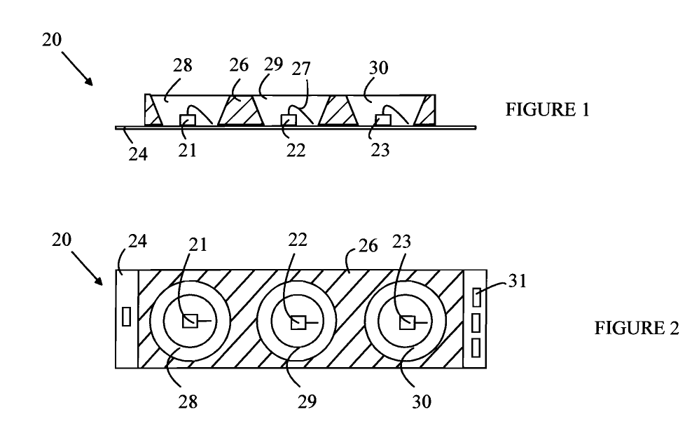

The manner in which the present invention provides its advantages can be more easily understood with reference to FIGS. 1 and 2. FIG. 1 is a cross-sectional view of a multi-LED package, and FIG. 2 is a top view of that multi-LED package. Package 20 includes three LEDs shown at 21-23 that are attached to a substrate 24. Substrate 24 is an insulating substrate having a plurality of conducting traces that terminate in pads 31 for providing connections between the LEDs and external circuit driving circuits. The number of such pads and traces depends on the particular circuit configuration, the number of LEDs, and other design criteria. The LEDs are connected to the conducting traces by wire bonds 27 and/or conducting pads on the bottom of the LED dies. The LEDs are located in reflecting cups such as cups 28-30 formed in layer 26 having an inner surface that is typically coated with a highly reflective material such as Al.

The interior of the cup is typically filled with an encapsulating material that protects the LEDs and any wire bonds. The encapsulant can also be used to provide a layer of phosphor over the LEDs for the purpose of converting light generated by the LEDs to light having a different spectrum. For example, in the case of “white” LEDs, the LEDs could emit light in the blue region of the optical spectrum and the phosphor could convert a portion of that light to light in the yellow region of the optical spectrum to provide an output spectrum that appears white to a human observer. In prior art devices, the cups are rigid structures constructed from plastics, ceramics, or metal.

As noted above, for many applications, the preferred encapsulant material is silicone, which can be incompatible with the material from which the rigid reflectors are constructed because of poor adhesion and/or different coefficients of thermal expansion. The problems associated with different thermal coefficients of expansion increase in severity as the power levels generated by the light source increase. LED light sources that are intended to replace conventional incandescent or fluorescent light sources are particularly problematic in this regard, since such light sources require both high power levels and inexpensive construction. Even when solid encapsulants are utilized, the differences in the thermal coefficient of expansion can cause problems in high power devices.

The present invention utilizes a flexible cup structure to reduce the problems associated with differences in the thermal coefficient of expansion between the encapsulant material and the material from which the cups are constructed. In principle, the encapsulant is bonded both to the cups and to the underlying circuit carrier. All three of these materials can have different thermal coefficients of expansion. The present invention provides improved performance by utilizing a cup structure in which the cups are formed from voids in a molded layer of material that is sufficiently flexible at the operating temperatures in question to accommodate dimensional changes arising from temperature changes that are expected during the operation of the light source. In practice, the operating temperatures can vary from −55° C. to 200° C. Hence, differences in the thermal coefficient of expansion can be accommodated because the cup layer can flex to accommodate the change in dimensions of the encapsulant and/or underlying circuit carrier as the light source is subjected to temperature cycling associated with turning the LEDs on and off.

The preferred material for the cups is silicone. This choice is particularly attractive in designs in which the encapsulant is also silicone, since the cup layer and encapsulant will have the same coefficients of thermal expansion, and hence, only differences between the thermal expansion coefficient of the underlying carrier and the silicone components need be accommodated. In addition, the problems associated with the bonding of the encapsulant layer to the cups can also be substantially reduced.

In addition to silicone, the material for the layer that implements the cups can be constructed from a wide variety of materials including flexible graphite, ceramic-fiber and fiberglass. In addition, high temperature polymers including fluoroplastics, flexible polyvinyl chloride, polyester, polyethylene, high temperature nylon, and polyhphenylene sulphite can be used.

The reflectors in the above-described embodiments include a reflective surface that reflects light leaving the side of the LED into a direction more nearly normal to the surface on which the die is mounted. The reflective surface can be provided by coating the surface with a reflective material such as silver or chrome to provide a mirror surface. This type of light source appears to be a point source in the far field.

While a point light source has many desirable benefits including the ability to image or collimate the source, many useful LED designs provide an extended light source, and hence, the advantages of providing a mirrored surface are less significant. For example, embodiments that utilize phosphor to convert part, or all of, the light from the LED to light of a different spectrum, the light source that is being imaged in the far field appears to be the phosphor containing encapsulant and not a point source on the LED die. The phosphor compositions that are typically utilized in such phosphor-converted LEDs are typically suspended particles. The light striking the phosphor particles is either absorbed or scattered. The light in the new spectral region that is emitted by a phosphor particle originates in that particle; hence, the phosphor generated light appears to come from an extended light source having the same dimensions as the phosphor encapsulant. Even the unconverted light, after several scattering events, appears to come from the extended light source. In fact, many partially converted light sources, such as “white light” sources, include additional particles within the encapsulant to scatter the unconverted light so that the unconverted light appears to originate from the same extended source as the converted light.

In some embodiments, a partially converted light source is provided by utilizing a soluble phosphor in the encapsulant. If diffusing particles are not provided in the encapsulant, it is sometimes advantageous to include some other mechanism to diffuse the light that is not converted so that the two different spectrums of light will appear to originate in the same light source. Utilizing a reflector that has a matte finish can provide the diffusing function in such cases.

In addition to the phosphor materials discussed above, the encapsulation material could also include dyes or other materials that selectively absorb light in one or more wavelength bands to provide a modified output spectrum. The dyes could be utilized alone or in combination with phosphor converting materials.

In embodiments in which a mirrored surface is not required, a flat white surface can be utilized for the reflector. Such a surface can be obtained by coating the surface with a white paint. Alternatively, the reflector layer itself can be impregnated with white particles such as TiO₂ to provide the white surface without requiring that the surface be coated in a separate fabrication operation.

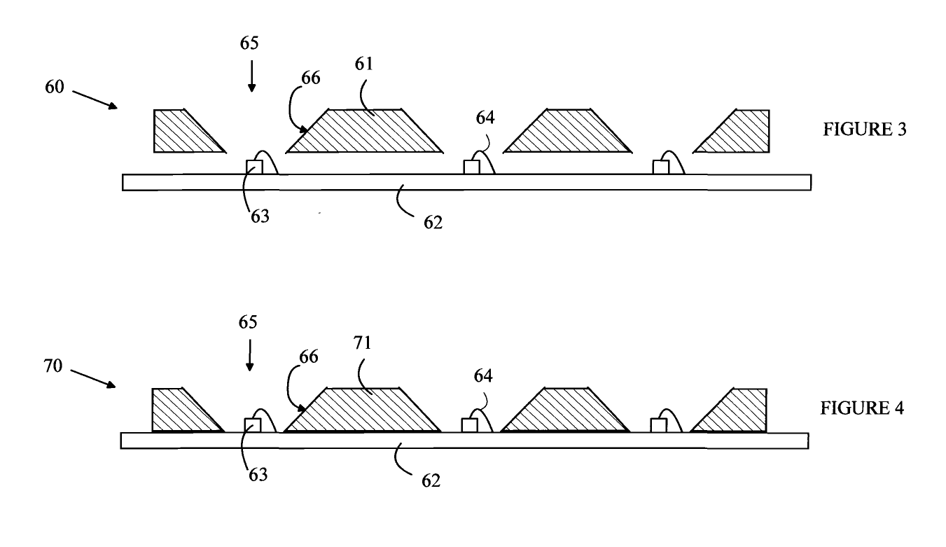

The reflector layer can be applied to the carrier as a separate component or molded in place on the carrier. Refer now to FIG. 3, which is a cross-sectional view of a portion of a light source according to one embodiment of the present invention. Light source 60 is constructed from a reflector layer 61 that is molded separately and then attached to circuit carrier 62. Reflector layer 61 is molded from a flexible compound such as silicone and includes holes such as hole 65 having reflective walls 66. The LED dies 63 can be attached to circuit carrier 62 and electrically connected to circuit carrier 62 prior to the attachment of reflector layer 61. In the example shown in FIG. 3, the LEDs are connected to one trace that is under die 63 and one trace that is connected to that die by a wire bond such as wire bond 64. The reflector layer could be bonded to the circuit carrier by a silicone-based cement in this embodiment. After the reflector layer is bonded to circuit carrier 62, the reflective cups can be filled with the appropriate encapsulant.

Alternatively, the reflector layer could be molded in place over the carrier. Refer now to FIG. 4, which is a cross-sectional view of a portion of a light source according to another embodiment of the present invention. Light source 70 is similar to light source 60 discussed above. However, light source 70 includes a reflector layer 71 that is molded onto circuit carrier 62. The layer can be molded either before or after the LEDs are attached and connected to circuit carrier 62.

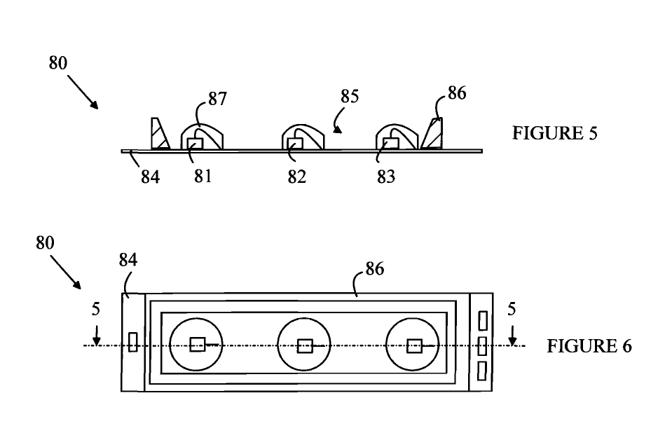

In the above-described embodiments of the present invention, each reflector housed one LED. However, embodiments in which multiple LEDs are located in a single reflector can also be constructed. Refer now to FIGS. 5 and 6, which illustrate a light source according to another embodiment of the present invention. FIG. 6 is a top view of light source 80, and FIG. 5 is a cross-sectional view of light source 80 through line 5-5 shown in FIG. 6. Light source 80 includes 3 LEDs 81-83 that share a single cavity 85 formed in flexible layer 86. The LEDs are attached to a rigid substrate 84 in a manner analogous to that discussed above. Each LED is individually encapsulated in an encapsulation layer 87; however, embodiments in which all of the LEDs are encapsulated in a single layer of encapsulant can also be constructed.

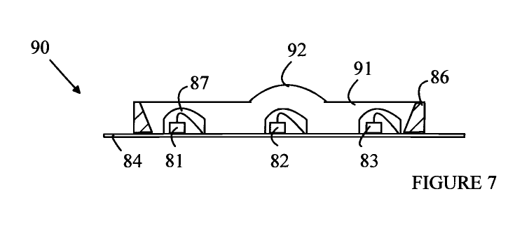

In addition, a two level encapsulation system could also be utilized. Refer now to FIG. 7, which is a cross-sectional view of a light source 90 according to another embodiment of the present invention. Light source 90 differs from light source 80 in that the individual LEDs are encapsulated in a first encapsulant 87, and then, the cavity is filled with a second layer of encapsulant 91. Encapsulant layer 91 can also include optical processing elements such as lens 92 that are molded into encapsulant layer 91. It should also be noted that the individual encapsulant layers might differ in composition from LED to LED. For example, different encapsulation layers could include different phosphors such that the light generated by the different LEDs differs in spectrum from LED to LED.

The embodiments of the present invention described above utilize a phosphor conversion material to alter the output spectrum of the light from the light source. However, luminescent materials can also be utilized for this conversion function.

The above-described embodiments of the present invention utilize reflectors with reflective walls. For the purposes of this discussion, a reflector wall is defined as being reflective if that wall reflects more than 90 percent of the light generated in said LED and any luminescent conversion material that strikes that wall.

The above-described embodiments utilize reflectors made from flexible materials. For the purposes of this discussion, the layer of material having the cavities that become the reflectors will be defined as being flexible if the material distorts sufficiently to accommodate differences in the thermal coefficient of expansion between the underlying circuit carrier and the reflector and the encapsulant layer and the reflector without distorting the encapsulant or causing the encapsulant and reflector to separate from one another.

Various modifications to the present invention will become apparent to those skilled in the art from the foregoing description and accompanying drawings. Accordingly, the present invention is to be limited solely by the scope of the following claims.

What is claimed is:

1. A light source comprising:
a rigid substrate having a first surface having a plurality of electrical traces formed thereon,
a first LED die disposed on said first surface and connected to two of said electrical traces,
a plurality of external electrical connections for accessing said electrical traces.
a reflector housing comprising a layer of flexible material having at least one cavity extending through said layer of flexible material being bonded to said first surface such that said cavity overlies said first LED die, said cavity having walls that reflect light generated in said first LED die.

2. The light source of claim 1 wherein said flexible material comprises silicone.

3. The light source of claim 1 wherein said cavity is filled with a transparent encapsulant such that said first LED die is encapsulated by said encapsulant and said rigid substrate.

4. The light source of claim 3 wherein said encapsulant comprises silicone.

5. The light source of claim 3 wherein said encapsulant comprises a first layer of encapsulant adjacent to said first LED die and a second layer of encapsulant that overlies said first layer of encapsulant, wherein light emitted by said first LED die is characterized by a first spectrum and wherein said first layer of encapsulant comprises a luminescent conversion material that alters said first spectrum to create light of a second spectrum that exits said light source.

6. The light source of claim 1 wherein said cavity walls comprise a layer of reflective material chosen from the group consisting of silver, nickel, nickel-gold and aluminum.

7. The light source of claim 1 wherein said transparent encapsulant comprises a lens.

8. The light source of claim 1 further comprising a second LED die, said cavity overlying said second LED die.
